(19) United States
(12) Patent Application Publication
(10) Pub. No.: US 2008/0245902 A1
(43) Pub. Date: Oct. 9, 2008

(54) Mixed-Mode Fuel Injector with a Variable Orifice

(75) Inventor: Deyang Hou, Sugar Land, TX (US)

Correspondence Address: QUANTLOGIC CORPORATION, 5111 AVONDALE DRIVE, SUGARLAND, TX, 77479, US

(73) Assignees: Deyang HOU, SUGAR LAND, TX (US); QUANTLOGIC CORPORATION, SUGAR LAND, TX (US)

(21) Appl. No.: 10/597,000

(22) PCT Filed: May 5, 2005
(86) PCT No.: PCT/IB2005/051474

§ 371 Date: Jun. 12, 2008

Related U.S. Application Data
(60) Provisional application No. 60/594,110, filed on Mar. 11, 2005.

(30) Foreign Application Priority Data
Jan. 18, 2005 (CN) 2005102000399

(51) Int. Cl. F02M 61/16

(52) U.S. Cl. 239/533.12; 239/533.4

(57) ABSTRACT

The invention disclosed a mixed-mode fuel injector with micro-variable-circular-orifice (MVCO), which is a fuel injection device for internal combustion engines, either diesel or gasoline engines. The fuel injector is a high-accuracy couple of components comprising a needle valve (1) and a nozzle body (5). Said needle valve is movable back and forth and received in said nozzle body to provide an opening position for fuel injection and a biased closing position. Said nozzle body has multiple-micro-channels (6) on the inner conical surface (C) close to the tip of the nozzle body. The injector has a MVCO (4) comprising a micro-variable-circular aperture and multiple-micro-channels, and has means of generating variable mixed-mode sprays of conical and multi-jet shapes, with a major homogeneous conical spray at low to medium injection loads.

### BACKGROUND OF THE INVENTION

1. Field of the Invention

The invention relates to a mixed-mode fuel injector with a micro-variable-circular-orifice (MVCO) and homogeneous atomization, and particularly to a fuel injector for a direct injection internal combustion engine, which can be either a spark-ignition gasoline engine or a compression-ignition diesel engine. The current filing is focused on the nozzle part of the fuel injector.

2. Description of the Related Art

The combustion process in a conventional direct injection Diesel engine is characterized by diffusion combustion with a multi-hole fuel injector. Due to its intrinsic non-homogeneous characteristics of fuel-air mixture formation, it is often contradictory to simultaneously reduce soot and NOx formation in a conventional diesel engine. Over last two decades, significant progress has been made for Diesel engine combustion (U.S. Pat. Nos. 4,779,587, 6,230,683), but further reducing emissions from Diesel engines to comply upcoming emission legislations still remains a challenge. Progress has been made in recent years for research of Homogeneous-Charge Compression-Ignition (HCCI) combustion engines. However, many issues remain to be solved to have a practical approach to control the ignition timing, the duration of combustion, the rate of combustion for HCCI engine for various load conditions. Current engine control strategies, such as U.S. Pat. No. 6,230,683, are effective but very complex and will increase the cost for applications. It seems more a viable solution to operate engine in a mixed-mode, or in HCCI mode or quasi-HCCI mode at low to medium loads, and in conventional spray combustion mode at high loads for the near future. It would be desirable to design a fuel injector which is suitable for this type of mixed-mode combustion, at least to provide most features desired by optimal engine combustion.

To improve combustion at the full load range, fine atomization with accurate control of doses and timing is needed. A well-known current art for improving atomization is to increase the number of holes of nozzles and decrease the diameter of nozzle holes, and use piezo actuators and high common rail pressure (U.S. Pat. Nos. 6,726,121, 6,557,779), such as BOSCH's piezo-injector with coaxial-vario-nozzle (Roger Busch, Advanced Diesel Common Rail Injection System for Future Emission Legislation, Diesel Engine Emission Reduction Conference, August, 2004, Coronado, Calif.). Such an approach, while it's effective for improving atomization and combustion, it does, at the same time, mandate a very complex structure and a much higher rail pressure, thus increase the power needed for fuel pump and manufacture cost of fuel systems, and increase the potential risks of fuel leaking.

3. Objectives and Advantages

Accordingly, several objectives and advantages of the invention are: (1) the micro-variable-circular-orifice (MVCO) is equivalent to a connection of infinite number of micro-holes, thus said fuel injector can form a variable micro aperture for fine atomization and ensure high fuel injection rate simultaneously. It enables using a single needle valve with micro lift, which is desired for working with a piezo actuator or hydraulic pressure amplifier to accurately control the fuel injection dose, atomization quality and give a much shorter response time. (2) said fuel injector, through its variable nature of injection sprays, provides a homogeneous fine atomization at low to medium loads, thus it is favorable for HCCI combustion mode, and provides fine atomization and sufficient penetration at high engine loads, thus it ensures engine power output. The varying micro-variable-circular-orifice (MVCO) feature can provide different sizes of the fuel injection exit cross-section area of the injector, which is superior to a conventional nozzle with fixed injection hole cross-section area, thus said MVCO can provide different fuel atomization rate and SMD (Sauter Mean Diameter) based on needs for optimal combustion for different load and speed conditions. (3) Since the micro-variable-circular-orifice (MVCO) keeps varying during the fuel injection process, the needle valve has self-cleaning effect, it is more robust for eliminating clogging. This feature improves reliability of fuel injection systems, it has more advantages than a conventional multi-hole nozzle, which is prone to get clogged in certain operating conditions and has heavy injection pressure loss when injection holes are too small. (4) The special design of the flow channel in the injector reduces pressure loss comparing with a conventional multi-hole nozzle through its novel fuel passage design near the MVCO, thus reduces the demand for extremely high rail pressure as required by small multi-hole nozzle, and reduces required fuel pump power. (5) Given many desirable features' for combustion, said fuel injector also has a relatively simple structure, instead of a complex structure with two needle valves, it uses a single needle valve to generate mixed-mode sprays through novel orifice design. It can save manufacturing cost. Said fuel injector provides a key device for meeting the current and future engine emission regulations.

### SUMMARY OF THE INVENTION

This invention provides a novel design of a mixed-mode fuel injector for mixed-mode HCCI-conventional combustion, more specifically a novel nozzle with a micro variable circular aperture and micro-channels to reduce pressure loss in the injector channel and provide a homogeneous initial fuel distribution. The mixed-mode fuel injector can generate a homogeneous fine atomization with sufficient penetration without relying on excessive high rail pressure. The fuel injector is a high-accuracy couple of components with a needle valve and a nozzle body, which system has a micro-variable-circular-orifice (MVCO) comprising a variable circular aperture between needle valve and nozzle body and multiple micro-channels on the inner conical surface closing to the nozzle body tip. The fuel injector is capable of generating variable mixed-mode sprays of conical and multi-jet shapes, with a major circularly homogeneous conical spray at low to medium engine loads, and mixed-mode sprays composed of a conical spray and multi-jets at high loads. The mixed-mode-spray ensures homogeneous atomization and sufficient penetration simultaneously.

### BRIEF DESCRIPTION OF THE DRAWINGS

FIG. 1 is a fragmentary sectional view of a first exemplary embodiment of an injector of the invention;

FIG. 2 is an amplified fragmentary sectional view of FIG. 1 for the micro-variable-circular-orifice (MVCO);

FIG. 3 is a bottom-up view of FIG. 1 for the micro-variable-circular-orifice (MVCO);

FIG. 4 is an illustration of the mixed-mode conical-multi-jet spray generated by the embodiment of the fuel injector illustrated in FIG. 1;

FIG. 5 is a fragmentary three-dimensional view of the fuel injector in FIG. 1;

In all the figures, 1—needle valve; 2—needle sealing surface; 3—needle head; 4—micro-variable-circular-orifice (MVCO) (including a circular aperture and micro channels); 5—nozzle body; 6—micro fuel channels; 7—tip surface of the nozzle body; A —up-rim of the needle head; B—the intersection of the needle head outer surface (or its extension) and tip surface of nozzle body; C—conical surface at the tip surface of the nozzle body; D—inner hole of the tip of the nozzle body; F—driving means, which can be active means provided by solenoid or piezo actuators, or a passive means by fuel pressure; S—high pressure fuel supply.

### DETAILED DESCRIPTION OF THE PREFERRED EMBODIMENTS

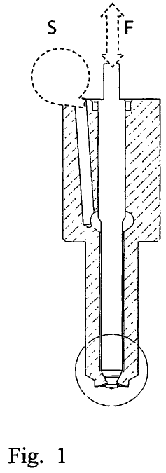

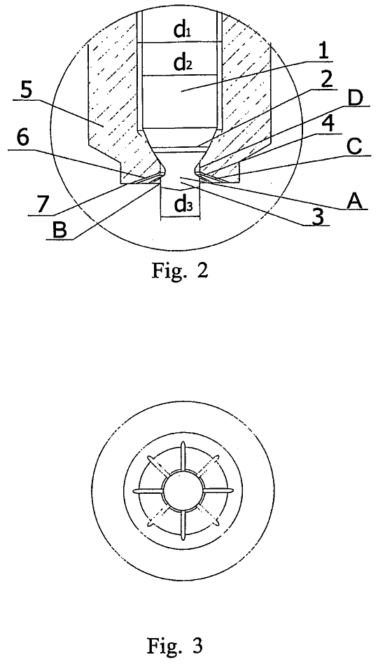

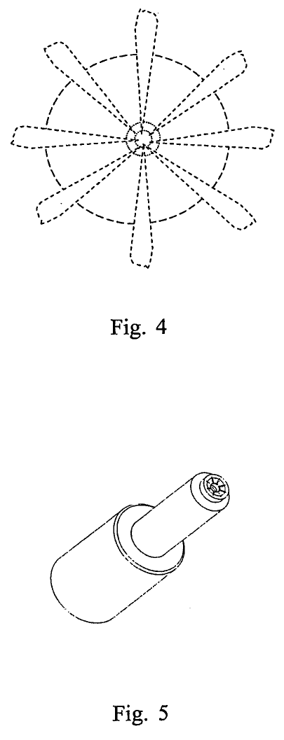

The mixed-mode fuel injector is a high-accuracy couple of components with a needle valve (1 in FIG. 2), which has a conical head for guiding fuel sprays, which has an opening and a biased closing position, which is movable back and forth and received in a nozzle body (5 in FIG. 2). The fuel injector has a micro-variable-circular-orifice (MVCO) (4 in FIG. 2) comprising of a variable circular ring aperture between said needle valve (1) and said nozzle body (5) and multiple micro-channels (6) on the inner conical surface (C) closing to the nozzle body tip (FIG. 1, FIG. 2, FIG. 3). Said needle valve is received in said nozzle body and has a biased closing position and an opening position decided by driving means such as actuators, when said needle valve is at its opening positions, fuel is discharged through said MVCO. The fuel injector is capable of generating variable mixed-mode sprays of conical and multi-jet shapes (FIG. 4), whereby generating a major circularly homogeneous conical spray at low to medium loads, and variable mixed-mode fuel sprays at high loads to ensure homogeneous atomization and sufficient penetration. Depending on the location of the micro-channels and whether the micro-channels are open channels or closed channels simply like conventional nozzle-holes, it can form different versions of spray shapes to satisfy different needs of penetration and atomization.

The mixed-mode fuel injector, wherein the needle lift is micro-motion with a range approximately 0-300 μm, the included angle of the conical sealing surface (2) at the nozzle body is approximately between 50-70 degree, the needle head diameter (d₃) is between 0.8-3.5 mm, the angle between the centerline of the nozzle body and the inner conical surface (C) at the nozzle body tip is approximately in the range of 35-75 degree.

A fuel injector, as a simplified version or alternative of said mixed-mode fuel injector (FIG. 2), wherein close to the tip surface (7) of nozzle body there is a conical surface (C), which is a smooth surface, the conical surface can be a single conical surface, or can be an integrated conical surface comprising two or more conical surfaces with different conical angles, or a diverging curve surface, the upper rim (A) of the needle head (3) is merged in the tip surface (7) of the nozzle body during the needle lifting, the needle head (3) can be partially or wholly merged in the tip surface (7) of the nozzle body during the needle lifting, when the needle valve is lifted, fuel is injected through the aperture (4) between the needle head and conical surface (C) of the nozzle body.

The mixed-mode fuel injector (FIG. 2), wherein close to the tip surface (7) of nozzle body there is a conical surface (C), the conical surface can be a single conical surface, or can be an integrated conical surface comprising two or more conical surfaces with different conical angles, or a diverging curve surface, the conical surface close to the needle valve is a surface with multiple micro-channels (6) with the shape of semi-circle, arcs, triangle, trapezoid or other polygons, or with helical micro-channels, the upper rim (A) of the needle head (3) is merged in the tip surface (7) of the nozzle body (5) during the needle lifting, the needle head can be partially or wholly merged in the tip surface (7) of the nozzle body during the needle lifting, when the needle valve is lifted, fuel is injected through the variable aperture between the needle head and conical surface (C) of the nozzle body, fuel is also injected through the multiple micro-channels (6). The upper surface of the needle head (3) and the conical surface (C) serves as guiding surfaces for sprays.

The mixed-mode fuel injector, wherein the fuel channel between the needle head (3) and conical surface (C) of the nozzle body is of converging-diverging nozzle shape, due to micro-needle-lift of the needle valve, the lifted minimum dimension of the aperture of the channel is approximately in the range of 30-125 μm, the minimum aperture is at the sealing surface (2) during the early stage of fuel injection. The minimum aperture is at the needle valve exit injection-cross-section (4) or at the sealing surface (2), depending on a specific design, during the middle stage of fuel injection, and the minimum aperture is at the sealing surface again during the late stage of fuel injection. During all fuel injection stages, the minimum aperture is approximately less than 125 μm, thus ensures fine atomization during all fuel injection stages.

The mixed-mode fuel injector, wherein the depth of conical surface (C) close to the nozzle exit is approximately in the range of 0.15-3 mm, the conical angle of conical surface (C) is approximately in the range of 80-150 degree.

The mixed-mode fuel injector (FIG. 1, FIG. 2), wherein there are approximately 4-20 micro-channels (6) with the cross-section shape of either semi-holes with the diameters approximately in the range of 50-300 μm, or other shapes as described above with the maximum dimension approximately between 50-400 μm (i.e., the geometric cross section of such a channel can fit in a circle with a diameter of 50-400 μm), the sizes of these micro-channels can be the same or varying depending on specific needs of atomization, these micro-channels can be homogeneously or non-homogeneously distributed on the conical surface (C).

The mixed-mode fuel injector, wherein at low to medium engine loads, fuel is mainly injected through the variable circular aperture between said needle head and said nozzle body, thus mainly forms a conical shape spray, while at high loads, fuel is injected through both the variable circular aperture and the micro-channels (6) on the conical surface (C), fuel forms mixed-mode conical-multi-jet shape sprays (FIG. 4), thus ensures both fine atomization and sufficient penetration.

A special version of fuel injector as described above has means of generating different shapes of fuel sprays by changing the magnitude of lift of said needle valve, wherein at low to medium injection loads, fuel is mainly injected through the variable circular aperture between the needle head and nozzle body, thus mainly forms a conical shape spray, while at high injection loads, the needle head can completely or partially block the variable circular aperture, whereby fuel is fully or mainly injected through the micro-channels, which can be open channels or closed channels depending on penetration needs, thus mainly forms conventional multi-hole sprays at high loads, whereby provides different penetration desired by engine combustion at different loads.

A special version of fuel injector as described above has a plurality of micro-channels underneath the said conical surface with the cross section shape of conventional nozzle holes, which can form sac-hole or valve-covered-orifice multi-hole type injector through blocking the circular aperture by the needle head at a predefined needle-lift range.

The mixed-mode fuel injector, wherein the angle between the centerline of the conical surface (C) and the centerline of the nozzle body (5) is approximately between 0-15 degree, depending on the angle between the centerline of the fuel injector and the centerline of the piston in the engine cylinder.

The mixed-mode fuel injector, is intended but not limited to direct injection diesel engines, direct injection gasoline engines, or other direct injection alternative fuel engines, it is intended for mechanical, electro-mechanical, piezo fuel injectors, or fuel injectors with hydraulic pressure amplifiers. Said fuel injector can also be used to inject other liquids, such as water, thus it can be used as a general purpose injector.

For small direct injection diesel engines, the major dimensions for the mixed-mode fuel injector are approximately: d₁=3.0-5 mm; d₁-d₂=0.3-0.8 mm; d₃=0.8-2.5 mm; the diameter of nozzle body hole—d₃=10-18 μm; the included angle at sealing surface at nozzle body=50-75 degree; the needle-lift range=30-240 μm; the cone angle of the conical surface at the tip of nozzle body=100-150 degree; the number of micro channels on the conical surface (C)=6-18; the maximum dimension of the micro channels (6)=50-280 μm.

For medium size direct injection diesel engines, the major dimensions for the mixed-mode fuel injectors are: d₁=4-6 mm; d₁-d₂=0.4-0.8 mm; d₃=1.0-3.0 mm. The cone angle of the conical surface (C)=120-150 degree; the maximum dimension of the micro channels (6)=50-400 μm; other parameters are similar to small diesel engines. The rail pressure for said mixed-mode fuel injector is about 800-1200 bar. While higher pressure is better, it is not mandated for fine atomization. The open injection pressure is approximately 240 bar or higher.

The mixed-mode fuel injector is intended for but not limited to internal combustion engines. The outer surface of the nozzle body can be of cylindrical, conical, or converging-diverging shape.

Those who are skilled in the art will find that it's easy to make minor changes to the nozzle structure following the same design concept in this invention, such as adding micro-channels or adding spirals on the needle head or on the conical surface (C) of the nozzle body, these ramifications are within the scope of this invention.

1. A mixed-mode fuel injector comprising:
(i) a nozzle body (5) comprising passages for fuel, an, inner cylindrical space for receiving a needle valve, and a conical surface (C) close to the tip (7) of the nozzle body for guiding a spray of fuel;
(ii) a needle valve (1), which has a converging-diverging conical head for guiding a spray of fuel and which is movable back and forth and received in said nozzle body, wherein said needle valve is at a biased closing position or an opening position defined by driving means; and
(iii) a micro-variable-circular-orifice (4) comprising a variable circular ring aperture between said needle valve and said nozzle body,
such that fuel is dischargeable in variable sprays of conical and conical-multi-jet shapes through said micro-variable-circular-orifice by lifting said needle valve at different magnitudes.

2. A mixed-mode fuel injector according to claim 1, wherein the micro-variable-circular-orifice (4) further comprises a plurality of micro-channels (6).

3. A mixed-mode fuel injector according to claim 1 or 2, wherein the conical surface (C) has a single conical surface.

4. A mixed-mode fuel injector according to claim 1 or 2, wherein the conical surface (C) is an integrated conical surface having two or more conical surfaces with different conical angles connected together.

5. A mixed-mode fuel injector according to claim 1 or 2, wherein the conical surface (C) is a diverging curved surface.

6. A mixed-mode fuel injector according to claim 1 or 2, wherein the needle lift for the opening position is approximately in the range of 0-300 μm, the needle head diameter is approximately in the range of 0.8-3.5 mm, and the angle between the centerline of the nozzle body (5) and the inner conical surface (C) at the nozzle body tip (7) is approximately in the range of 35-75 degrees.

7. A mixed-mode fuel injector according to claim 2, wherein the plurality of micro-channels (6) is on the said conical surface (C) with cross sections that are one or more of semi-circles, arcs, triangles, trapezoids or other polygons.

8. A mixed-mode fuel injector according to claim 2, wherein the needle head (3) remains at least partially received within the tip (7) as the needle valve (1) is moved back and forth between the biased closing position and opening position such that when fuel is injected through the micro variable aperture (4) between the needle head and said conical surface of the nozzle body, fuel is also injected through the multiple micro-channels (2), the upper surface of the needle head and the conical surface serve as guiding surfaces for fuel sprays.

9. A mixed-mode fuel injector according to claim 7, wherein there are about 4-20 micro-channels (6) with the cross-section of semi-circles with the diameters approximately in the range of 50-300 μm.

10. A mixed-mode fuel injector according to claim 7, wherein there are about 4-20 micro-channels (6) having a cross-section other than semi-circles with the maximum dimension approximately between 50-400 μm.

11. A mixed-mode fuel injector according to any of claims 2 to 10, wherein the sizes of said micro-channels (6) are the same.

12. A mixed-mode fuel injector according to any of claims 2 to 10, wherein the sizes of the micro-channels (6) are different depending on specific needs of atomization.

13. A mixed-mode fuel injector according to any of claims 2 to 12, wherein the said micro-channels (6) are distributed on or under the conical surface (C) so that they are open channels or closed channels.

14. A mixed-mode fuel injector according to claim 2, has a plurality of micro-channels underneath the said conical surface (C), forming a sac-hole or valve-covered-orifice multi-hole type injector through blocking the circular aperture by the needle head at a predefined needle-lift range.

15. A mixed-mode fuel injector according to claim 2, wherein different shapes of fuel sprays are generated by changing the magnitude of lift of said needle valve (1) and the needle valve is arranged within the nozzle body (5) so that, at low to medium injection loads, fuel is mainly injected through the variable circular aperture between the needle head (3) and nozzle body (1), thus mainly forms a conical shape spray, while at high injection loads, fuel is injected through both the variable circular aperture between the needle head and nozzle body and the micro-channels (6), thus forms a mixed-mode conical-multi-jet shape spray, whereby provides different atomization desired by engine combustion at different loads.

16. A mixed-mode fuel injector according to claim 2, wherein different shapes of fuel sprays are generated by changing the magnitude of lift of said needle valve (1) and the needle valve is arranged within the nozzle body (5) so that, at low to medium injection loads, fuel is mainly injected through the variable circular aperture between the needle head (3) and nozzle body, thus mainly forms a conical shape spray, while at high injection loads, the needle head can completely or partially block the variable circular aperture, whereby fuel is fully or mainly injected through the micro-channels (6), which can be open channels or closed channels depending on penetration needs, thus mainly forms conventional multi-hole sprays at high loads, whereby provides different penetration desired by engine combustion at different loads.

17. A mixed-mode fuel injector according to claim 1 or 2, wherein the fuel channel between the needle valve (1) and the nozzle body (5) is of converging-diverging shape and by lifting said needle valve at different magnitudes, the minimum cross-section is at the sealing surface during the early stage of fuel injection, the minimum cross-section is at said micro-variable-circular-orifice (4) or at the sealing surface during the middle stage of fuel injection, and the minimum cross-section is at the sealing surface again during the late stage of fuel injection, whereby it has means of ensuring fine atomization during all fuel injection stages.

18. A mixed-mode fuel injector according to claim 1 or 2, wherein the angle between the centerline of the conical surface (C) and the centerline of the nozzle body (5) is approximately 0-15 degrees, depending on an angle between a centerline of the fuel injector and a centerline of a piston in an engine cylinder.

19. A mixed-mode fuel injector according to any of the preceding claims, wherein the fuel injected is one or more of diesel fuels, gasoline fuels, alternative fuels, mixtures of water and fuels, pure water or liquid exhaust cleaning additives in which case, the fuel injector is a general purpose injector.

20. A mixed-mode fuel injector according to claim 1, wherein the needle valve (1) is passively driven by high fuel pressure which provides said driving means.

21. A mixed-mode fuel injector according to claim 1, wherein the needle valve (1) is actively driven by an actuator which provides said driving means.

22. A mixed-mode fuel injector according to claim 21, wherein the actuator is a solenoid or a piezo actuator.

23. A mixed-mode fuel injector, which has a micro-variable-circular-orifice (MVCO) comprising a variable circular ring aperture and multiple-micro-channels as in claim 2, wherein the MVCO is used as a sole orifice or in-combination with other multi-hole conventional orifice.
